(19) United States
(12) Patent Application Publication
(10) Pub. No.: US 2006/0112581 A1
(43) Pub. Date: Jun. 1, 2006

(54) Alignment guide for a power tool

(76) Inventors: Bernhard Nortmann, Harbour Plaza Resort City (HK); Todd M. Chipner, Hong Kong (HK); Huabo Li, Nanning City (CN)

Correspondence Address: BRINKS HOFER GILSON & LIONE, P.O. BOX 10395, CHICAGO, IL, 60610, US

(21) Appl. No.: 11/000,789

(22) Filed: Dec. 1, 2004

(51) Int. Cl. B23Q 17/22

(52) U.S. Cl. 33/638

(57) ABSTRACT

A power tool comprises a spindle, a slide, and an alignment guide. The spindle is attached to the power tool and operably supported relative to a work piece wherein the spindle defines an axis of operation for the power tool. The slide is moveably attached to the power tool. The alignment guide is secured to the slide and has a first laser and a second laser. The first laser projects a first laser beam in a first plane and the second laser projects a second laser in a second plane. The first plane and the second plane intersect along the axis of operation.

The present invention relates to a guide for a power tool, and more particularly to an alignment guide for a drill press.

A typical drill press has a table attached to a support arm, which, in turn, is supported by a vertical post on a base. A head is supported at the top of the post, and a motor-driven drill chuck extends downwardly from the head. The chuck holds a drill bit and is raised and lowered towards the table to drill a hole in the work piece.

In order to accurately position a hole on a work piece with such a drill press, an operator must perform a time-consuming process of raising and lowering the head while test drilling holes and readjusting the position of the work piece. Optical alignment systems have been developed to address this problem. These alignment systems are mounted to the drill press and project intersecting lines onto the work piece. The alignment systems are calibrated so that the intersection point of the two projected lines corresponds with the axis of the drill bit. For example, U.S. Patent Application 2003/0095840 to Wang discloses a laser positioning system for an aperture-processing machine where the lasers are fixed within the head. When larger drill bits or hole saws are used in the drill press, however, the projected laser beams may be partially obstructed so that the lines projected on the work piece do not intersect. This increases the setup time for an operator, forcing him or her to align the projected laser lines with some other mark, temporarily remove the drill bit, or extrapolate the intersection point of the projected laser lines, for example.

U.S. Patent Application 2004/0032587 to Garcia discloses an optical alignment system for a power tool having a horizontal spacing connector that allows the distance between a first and second laser generator to be adjusted. The use of such a spacing connector, however, requires an operator to realign the lasers to project laser lines that intersect at the drill bit axis, increasing the set up time. In addition, because the alignment system is mounted on the drill bit quill, it may interfere with the work piece or other parts as the drill bit is lowered. The present invention addresses these and other needs.

### SUMMARY

Accordingly, embodiments of the present invention provide a new and improved alignment guide for a power tool. The alignment guide may be secured to a slide that may be integrally mounted to the power tool or attached as an accessory. A rotary handle is mounted to the power tool, and coupled with a transmission. The transmission engages a rack located on the slide. The slide allows the alignment guide to be adjustably positioned relative to the work piece. Provided the slide moves parallel to the drill bit axis, the alignment guide does not need to be realigned. In addition, the alignment guide may be equipped with at least one lamp, such as a light emitting diode, to provide light onto the work piece.

According to one aspect of the invention, a power tool includes a spindle, a slide, and an alignment guide. The spindle is attached to the power tool and operably supported relative to a work piece wherein the spindle defines an axis of operation for the power tool. The slide is moveably attached to the power tool. The alignment guide is secured to the slide and has a first laser and a second laser. The first laser projects a first laser beam in a first plane and the second laser projects a second laser in a second plane. The first plane and the second plane intersect along the axis of operation.

According to another aspect of the invention, a drill press comprises a vertical support post, a head, a slide, and an alignment guide. The head is mounted to the support post and has a rotatable chuck, wherein the rotatable chuck defines an axis of operation. The slide is attached to the drill press and the alignment guide is secured to the slide. The alignment guide has a first laser projecting a first laser beam in a first plane and a second laser projecting a second laser beam in a second plane. The first plane and the second plane intersect along the axis of operation.

Yet another aspect of the invention includes a drill press that includes a base, a vertical support post, a head, a slide, and an alignment guide. The vertical support post is attached to the base. The head is mounted to the support post and has a rotatable chuck, wherein the rotatable chuck defines an axis of operation. The slide is moveably attached to the drill press, and the alignment guide is secured to the slide. The alignment guide has a first laser projecting a first laser beam in a first plane and a second laser projecting a second laser beam in a second plane, wherein the second laser is positioned at a fixed distance from the first laser. The first plane and the second plane intersect along the axis of operation.

### BRIEF DESCRIPTION OF THE DRAWINGS

FIG. 1 shows a perspective view of the alignment guide of the present invention, shown mounted to a drill press.

FIG. 2 is a side view of the alignment guide of the present invention, shown mounted to a drill press.

FIG. 3 is a front view of the alignment guide of the present invention, shown mounted to a drill press.

FIG. 4 is a perspective view of the alignment guide of the present invention.

FIG. 5 is a side view of the alignment guide of the present invention.

FIG. 6 is a top view of the alignment guide of the present invention.

FIG. 7 is a side view of the alignment guide of the present invention showing a partial cross-section view taken along section B-B of FIG. 6, showing the battery compartment and the laser generator.

FIG. 8 is a perspective view of one embodiment of the slide of the present invention.

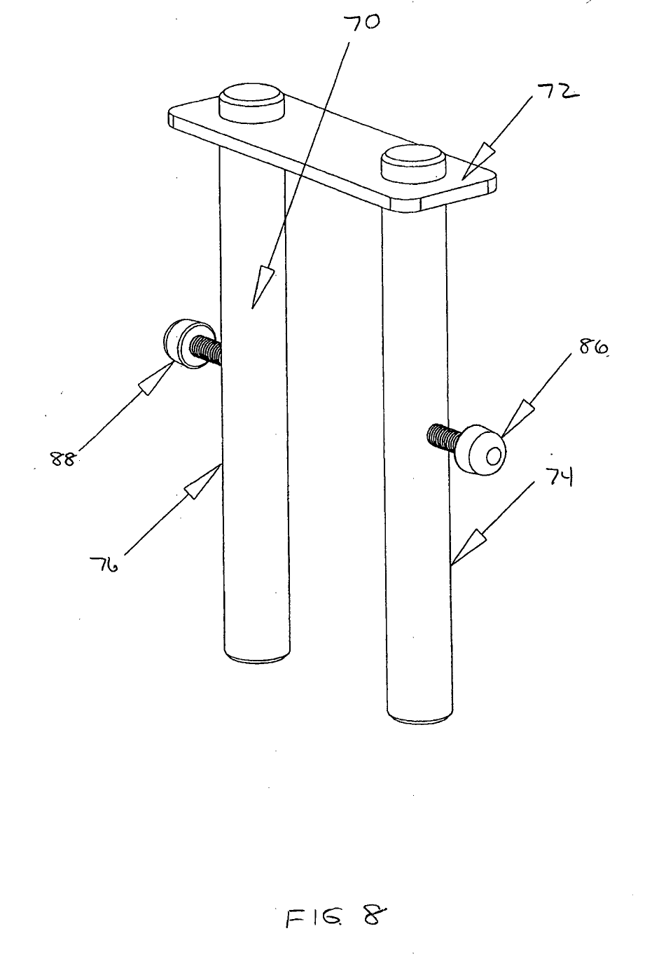

FIG. 9 is a side view of the alignment guide of the present invention shown mounted to the slide shown in FIG. 8.

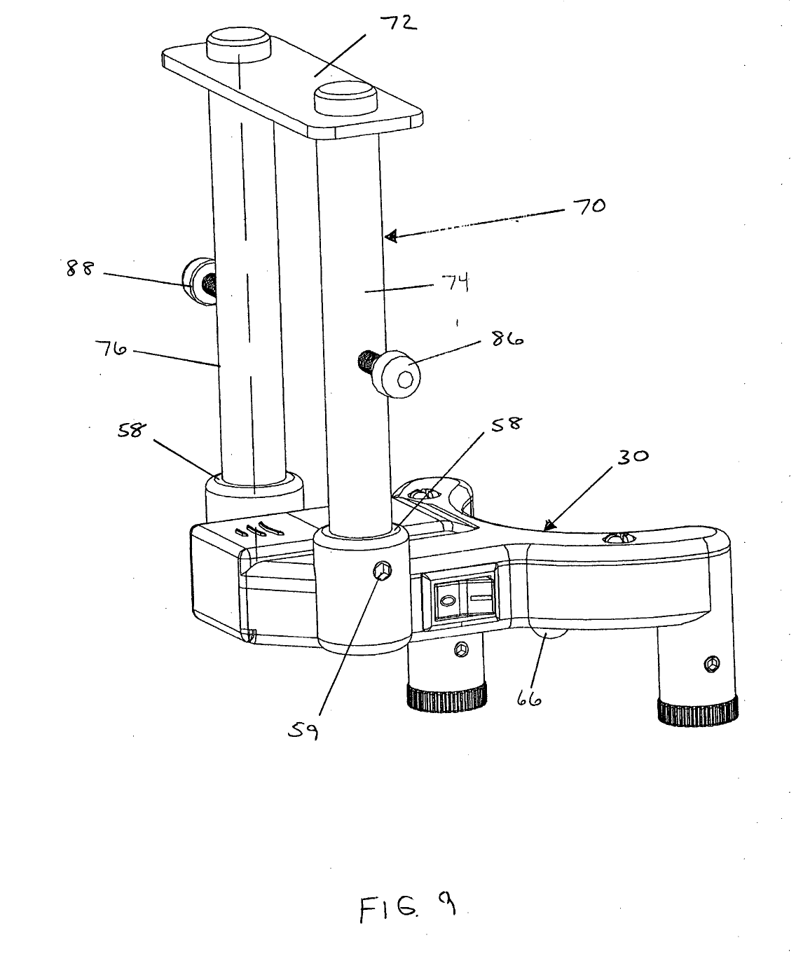

FIG. 10 is a perspective view of another embodiment of the slide of the present invention.

FIG. 11 is a perspective view showing the alignment guide of the present invention mounted to the slide shown in FIG. 10.

FIG. 12 is a perspective view showing a geometric relationship of the laser generators and projected laser beams of the alignment guide of the present invention to the drill bit.

FIG. 13 is another perspective view showing a geometric relationship of the laser generators and projected laser beams of the alignment guide of the present invention to a hole saw.

FIG. 14 is a perspective view of the slide of the present invention shown mounted to a drill press behind the drill chuck.

FIG. 15 is a perspective view of the slide of the present invention shown mounted to a drill press in front of the drill chuck.

FIG. 16 is a perspective view of the slide of the present invention shown mounted to the support post of a drill press.

### DETAILED DESCRIPTION

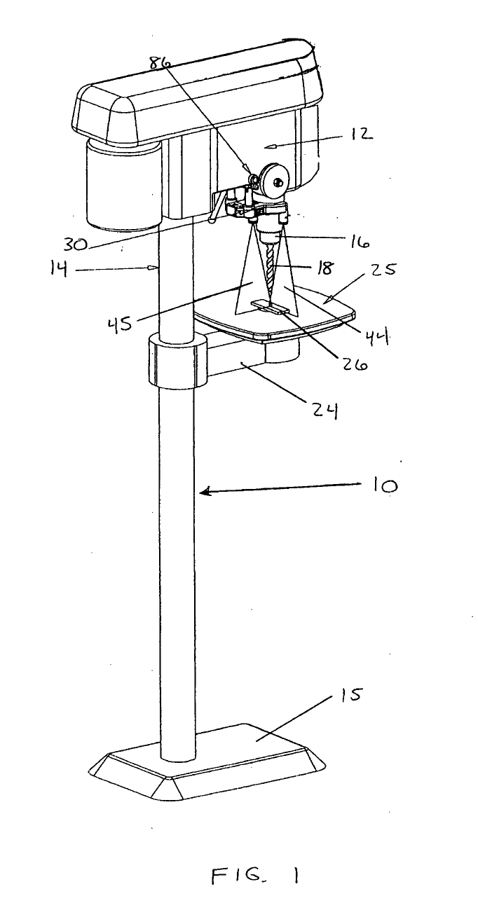

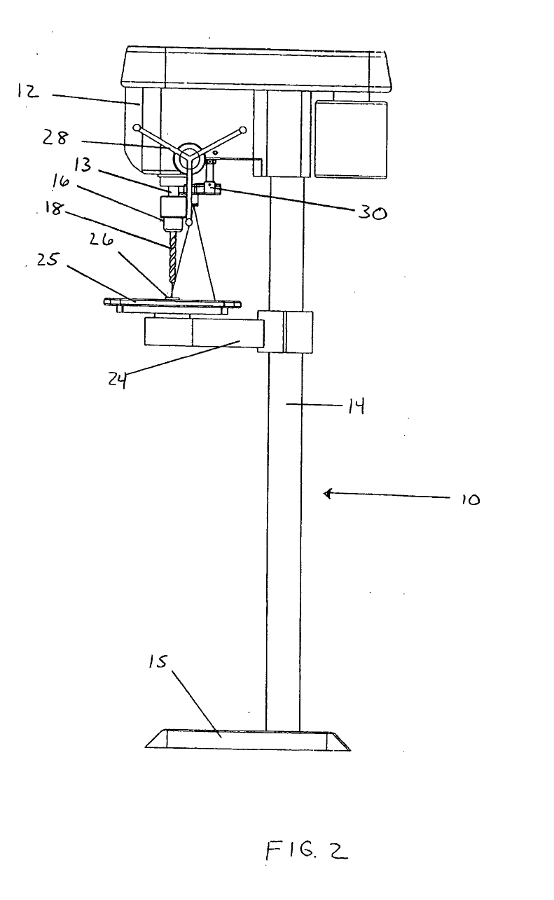

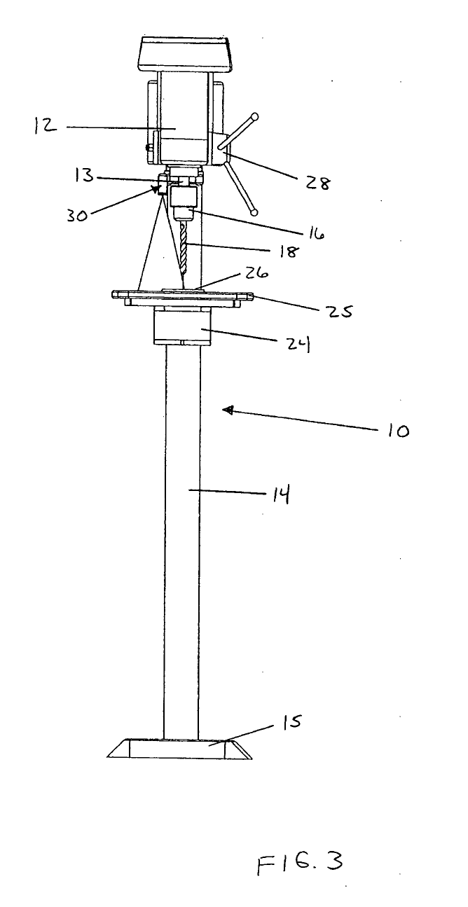

Referring now to FIGS. 1-3, an alignment guide 30 according to the present invention is shown mounted to a drill press 10. The drill press 10 includes a support post 14, a base 15, and a head 12. The support post 14 may have a hollow cylindrical shape to fit within an opening formed in the base 15. Generally, the base 15 supports the support post 14 and it extends generally vertically from the base 15. The head 12 includes an opening that receives a post 14 and is supported thereon. A conventional spindle 13 extends from head 12, with a chuck 16 coupled to spindle 13. A rotatable handle 28 for raising or lowering the chuck 16 extends from head 12. A conventional drive mechanism (not shown) for the spindle 13 and chuck 16 is also disposed within head 12. A drill bit 18 or a hole saw 19 may be mounted in chuck 16 to rotate about an axis of operation 20. A table support 24 is mounted to post 14 to support a table 25 positioned under chuck 16. A work piece 26 may be placed onto the table 25 so that the drill bit 18 or the hole saw 19 may perform various machining operations upon it.

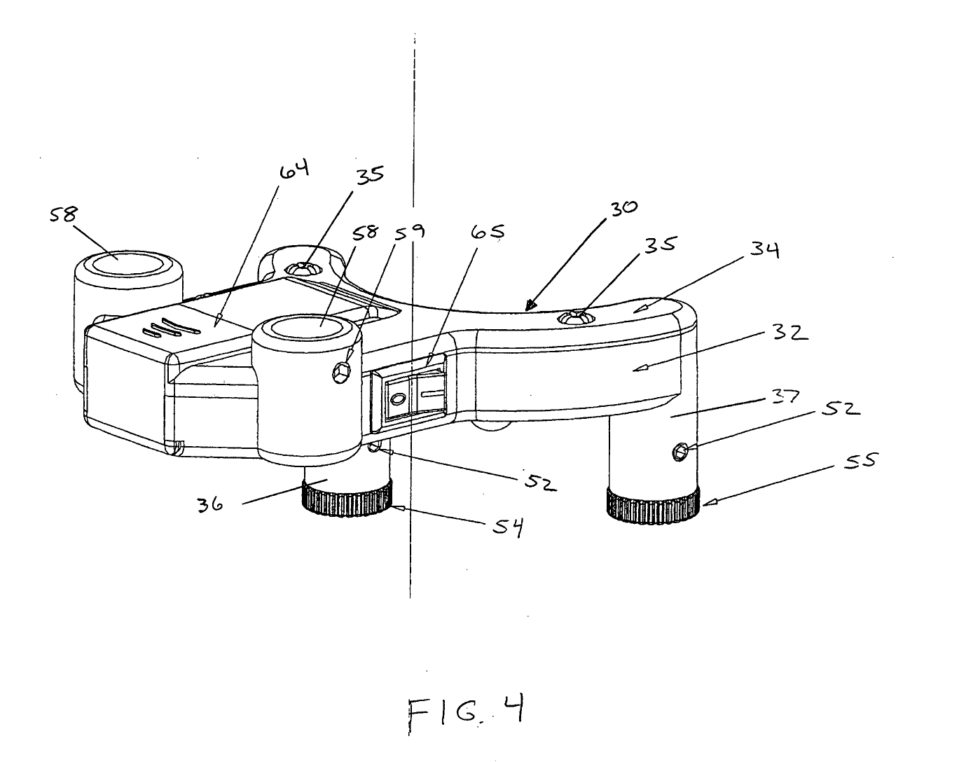

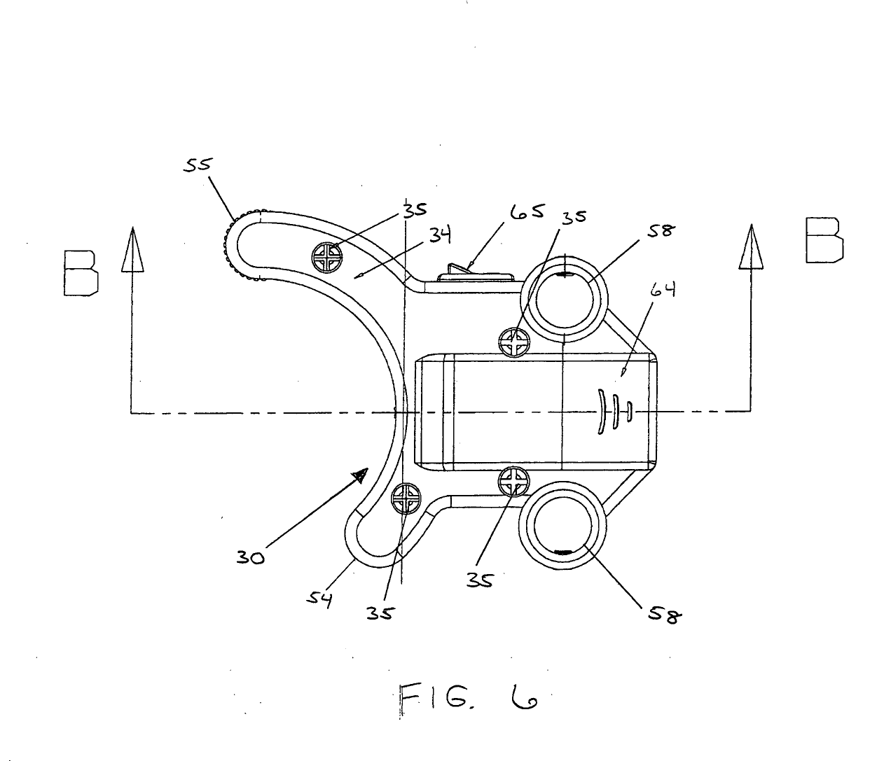

Referring to FIGS. 4-7, the alignment guide 30 includes a housing 32 and a cover 34. As seen in FIG. 6, the cover 34 may be secured to a housing 32 by screws 35, although other means of joining the two parts may be used, such as an adhesive, a snap or interference fit, etc. The housing 32 and the cover 34 may be injection molded from a suitable plastic such as polycarbonate, acetal, or ABS (acrylonitrile-butadiene-styrene). The housing 32 includes a first receptacle 36 and a second receptacle 37. The first and second receptacles 36, 37 may be integrally formed as cylindrical bores in housing 32. Alternatively, the first and second receptacles 36, 37 may be configured so that they are movable with respect to the housing 32. In this regard, the entire receptacle 36, 37 or portions of it may be movable with respect to the housing 32.

A first laser generator 40 is mounted in the first receptacle 36, and a second laser generator 41 is mounted in the second receptacle 37. Set screws 52 are positioned in a transverse bore 51 in each of the first and the second receptacles 36, 37 to secure the laser generators 40, 41. Of course, other known securing apparatus can be used to more easily facilitate the securing of the laser generators 40, 41. For example, a rotatable handle or a cam having a lever or other apparatus suitable for securing the laser generators 40, 41 can be used.

The laser generators 40, 41 may be commercially available laser generators that produce a planar, fan shaped beam of light. A first adjustment ring 54 is rotatably positioned on the first receptacle 36 to adjust the laser beam generated by the first laser generator 40. A second adjustment ring 55 is rotatably positioned on the second receptacle 37 to adjust the laser beam generated by the second laser generator 41. The adjustment will be explained in further detail below.

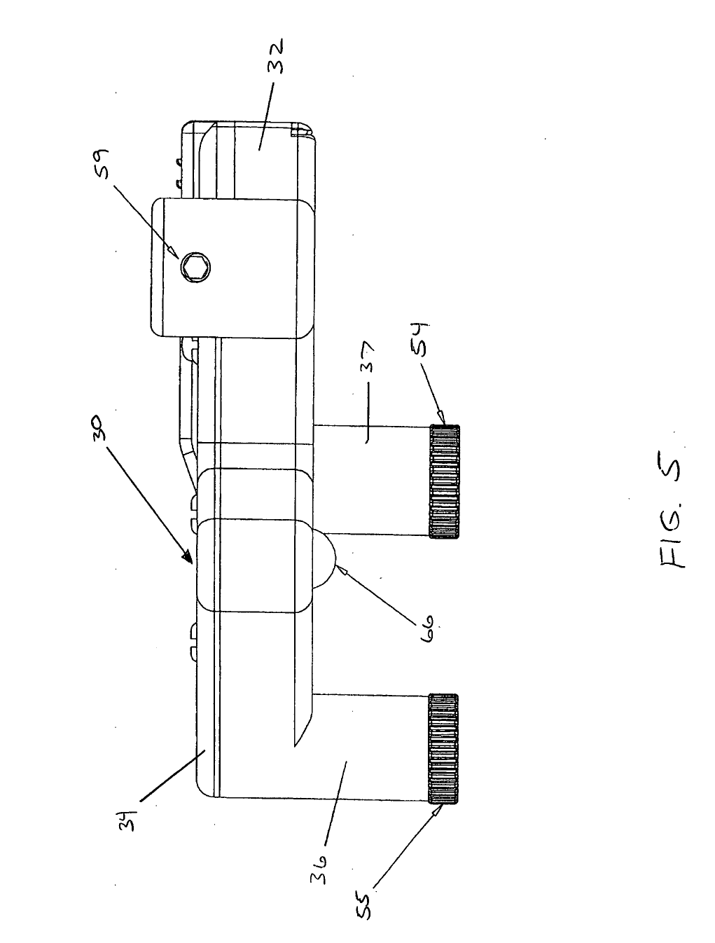

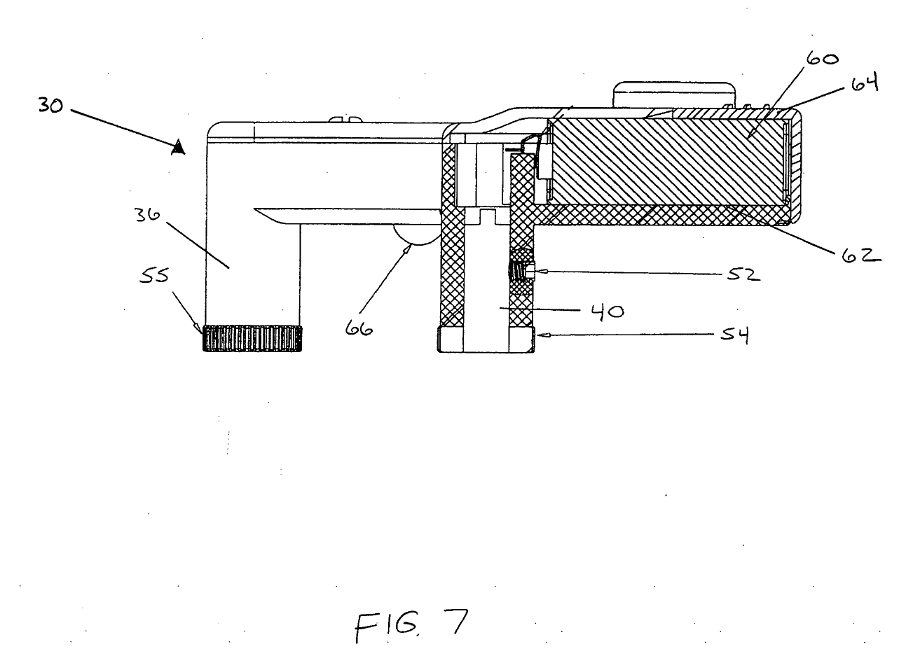

As seen in FIGS. 5 and 7, at least one lamp 66 may be associated with the alignment guide 30 to illuminate the work piece 26. The lamp 66 may be integrally mounted in the alignment guide 30 or may be attached to the alignment guide 30 in any known or suitable manner. The lamp 66 is preferably a light emitting diode (LED); however, other types of lights may be used, such as incandescent or halogen bulbs, lasers, etc.

A battery 60 housed in a battery receptacle 62 in the alignment guide 30 may power the laser generators 40, 41 and the lamp 66. A battery cover 64 is secured to the alignment guide 30 to cover and secure the battery 60 within the battery receptacle 62. The battery cover 64 provides easy replacement of the battery 60. Alternatively, the laser generators 40 and 41 and the lamp 66 may be powered by AC power, either directly from the AC line current or through electrical cables connected to the electrical system of the drill press 10. An AC to DC converter and voltage reducers may be required if AC line current is used, as is known.

A power switch 65 allows power from the battery 60 or other power source to actuate the laser generators 40, 41 and the lamp 66. Alternatively, the switch 65 may be configured to separately allow power to the laser generators 40, 41 or the lamp 66, or an additional switch may be used.

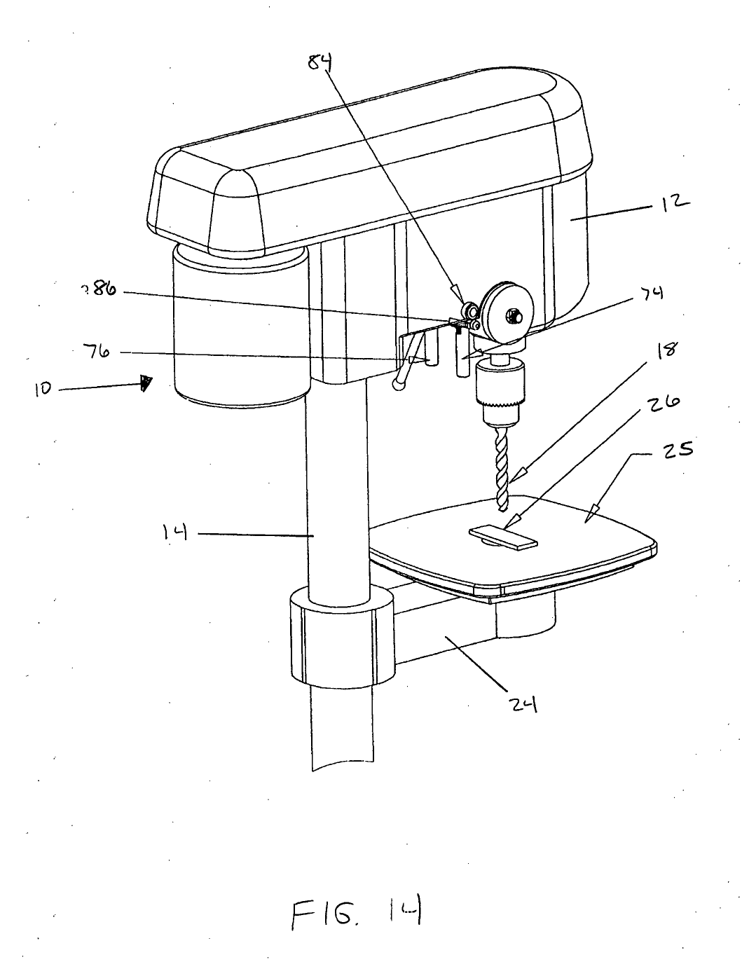

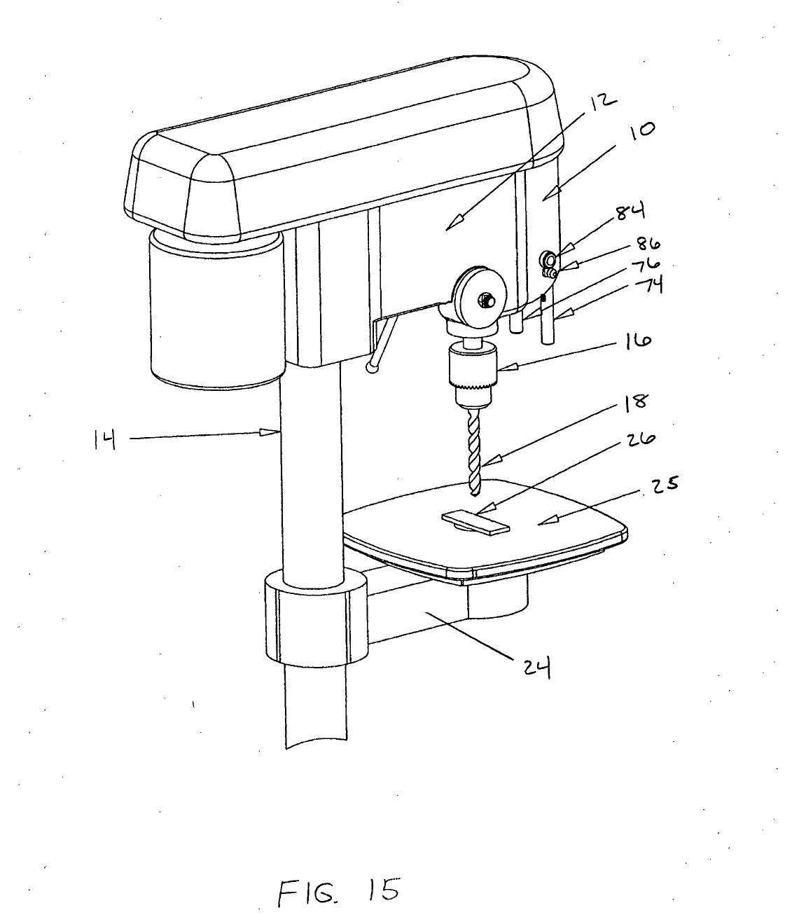

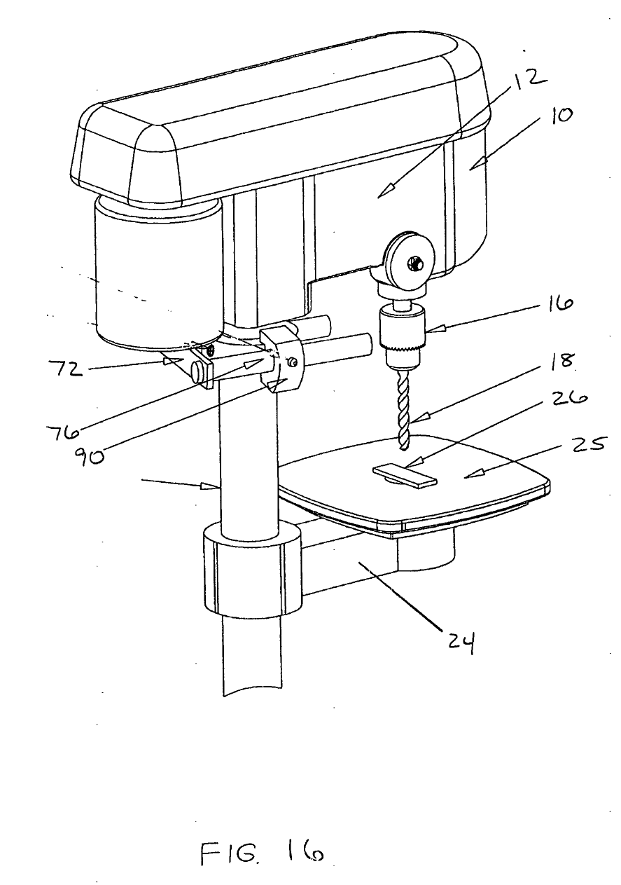

The alignment guide 30 is coupled to the drill press 10 through a slide 70. The slide 70 comprises a bracket 72, a first guide shaft 74 that extends from bracket 72, and a first locking knob 86. As best seen in FIGS. 1-3 and 14-15, the slide 70 may be mounted to the head 12, with the bracket 72 positioned in the head 12. Alternatively, the slide 70 may be integrally formed as part of the head 12. In yet another alternative, as seen in FIG. 16, the bracket 72 may be mounted to the support post 14 through a clamp 90. The bracket 72 may also have a second guide shaft 75.

The first locking knob 86 extends transversely from the first guide shaft 74 and secures the position of the alignment guide 30 with respect to the drill press 10, clamping to the head 12 or to the clamp 90. A second locking knob 88 may also extend transversely from the second guide shaft 75 to provide additional clamping. One skilled in the art will understand that an alternative locking apparatus can be used. For example, a locking handle or a cam can be used to provide locking engagement. Guide shafts 74, 75 are inserted into the shaft receptacles 58 formed in the alignment guide 30. Inserts, such as bearings, may be placed within the shaft receptacles 58 to aid in aligning the guide shafts 74, 75 with the alignment guide 30.

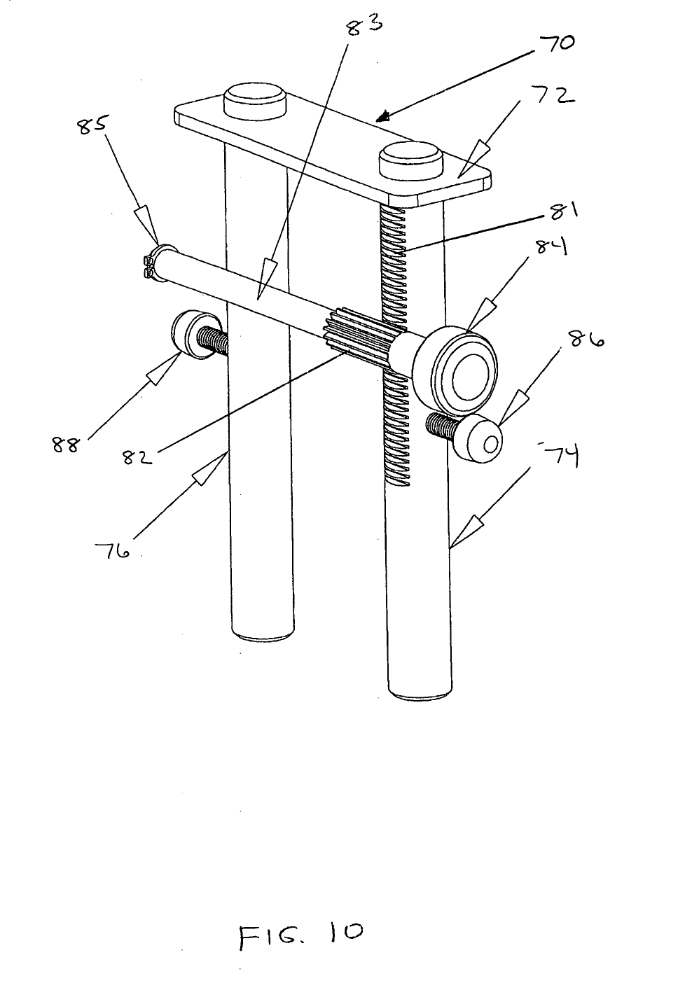

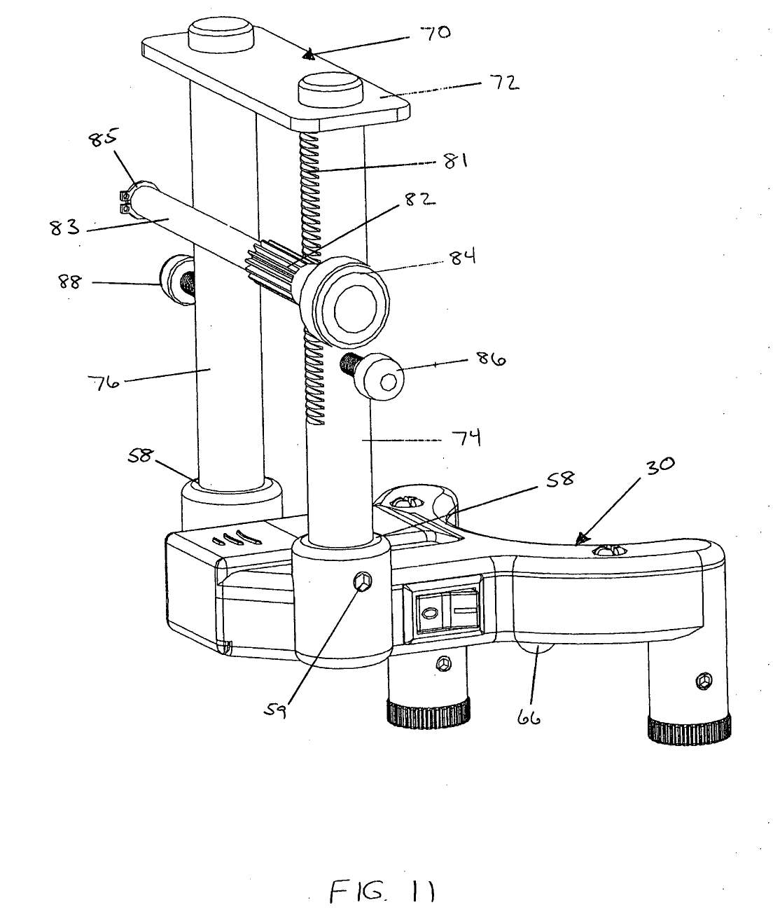

As seen in FIGS. 10-11, a transmission may couple the slide 70 with the head 12. The transmission includes a rack 81, a pinion 82, a pinion shaft 83, and a rotating knob 84. The rack 81 may be integrally formed along the first guide shaft 74, with the pinion 82 coupled with the rack 81. A pinion shaft 83 extends from the pinion 82 through the head 12. A rotating knob 84 and a C-ring 85 are positioned at opposite ends of the pinion shaft 83 to axially secure the pinion shaft 83 to the head 12. By rotating the knob 84, the pinion shaft 83 rotates, which in turn rotates the pinion 82. The pinion 82 engages the rack 81, causing the first guide shaft 74 and the alignment guide 30 to move up or down.

Various parameters of the pinion 82 and the rotating knob 84, such as the outer diameters or the radii, may be selected so that a desired mechanical advantage is achieved, where the displacement or movement of the slide 70 and the alignment guide 30 relative to the head 12 is a particular ratio to the rotational movement of the rotating knob 84. A gear ratio of approximately 1:2 is illustrated in FIGS. 10-11. However, the sizes of the pinion 82 and the knob 84 can be selected so that other mechanical advantages are achieved, such as 1:4, 2:1, or 4:1, providing for increased or reduced adjustment sensitivity, as desired.

In operation, the switch 65 actuates the laser generators 40, 41 and the lamp 66. The first adjustment ring 54 is rotated until the fan-shaped first laser beam 44 projected by the first laser generator 40 is coplanar with the drill bit axis of operation 20. Similarly, the second adjustment ring 55 is rotated until the fan-shaped second laser beam 45 projected by the second laser generator 41 is also coplanar with the drill bit axis 20. The set screws 52 are then tightened to secure this orientation. The alignment guide 30 is preferably designed to have the first laser beam 44 oriented perpendicular to the second laser beam 45, although the alignment guide 30 may be designed to permit other angles of intersection.

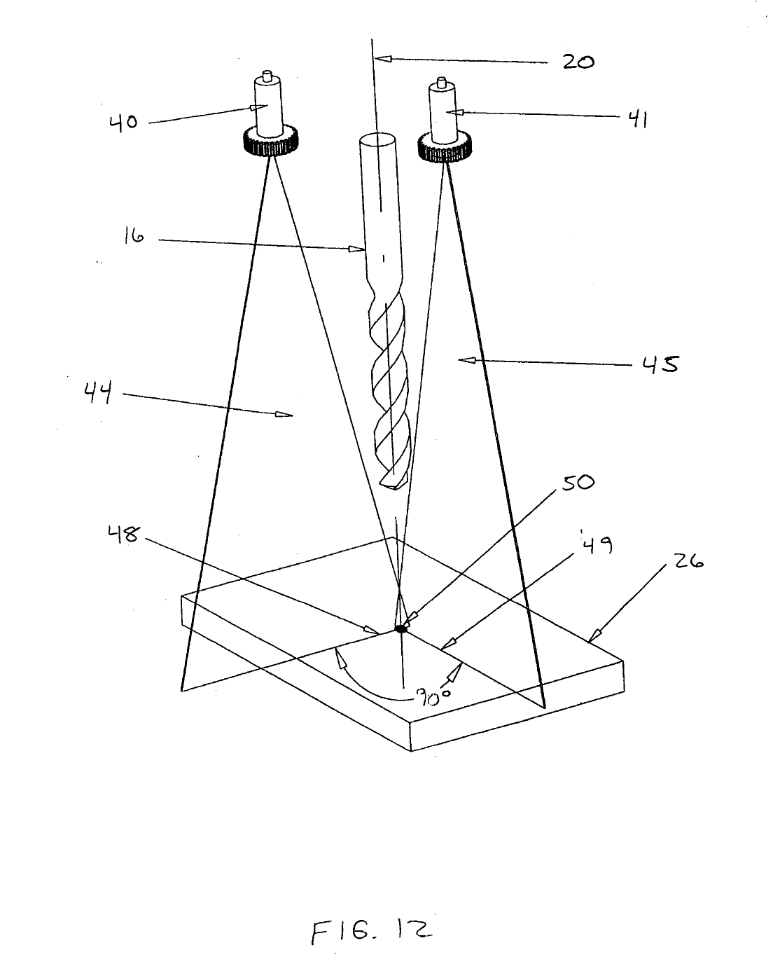

Once the alignment guide 30 has been aligned with respect to the drill bit axis 20, the alignment guide 30 projects a first laser line 48 and a second laser line 49 with an intersection point 50 that coincides with the projection of the drill bit axis 20 onto the work piece, as best seen in FIG. 12. By aligning this intersection point 50 and the laser lines 48, 49 with a reference mark 51 on the work piece, an operator can accurately locate a hole.

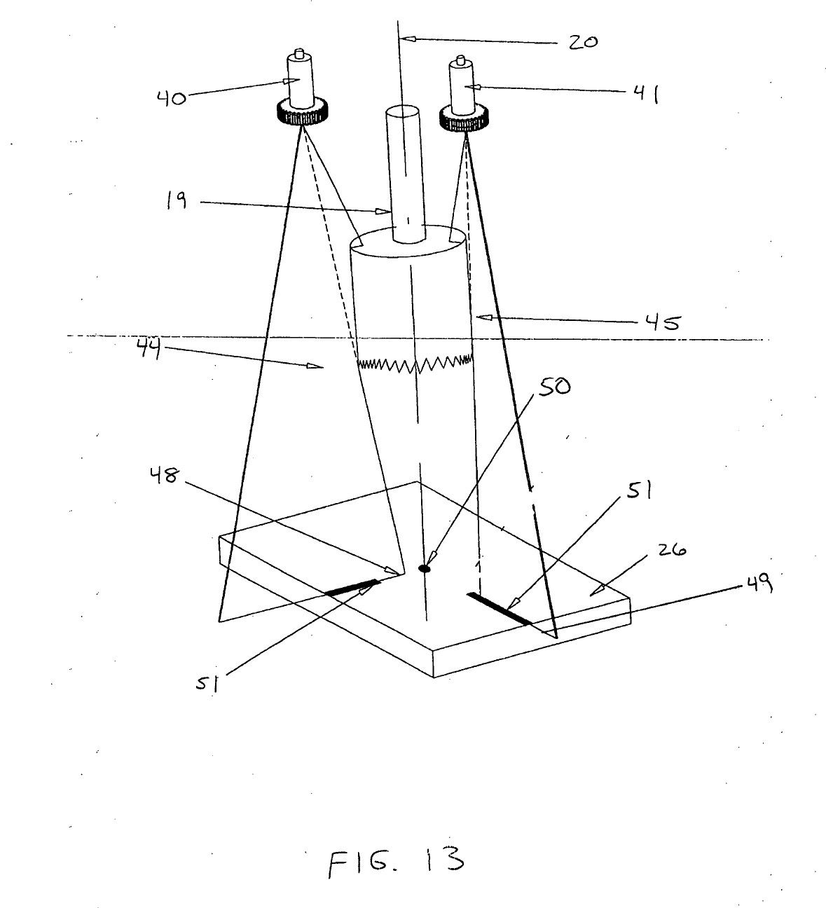

As seen in FIGS. 12-13, when large diameter drill bits 18 or hole saws 19 are placed into the chuck 16, the drill bit 18 or hole saw 19 may obstruct a portion of the projected laser beams 44, 45, which blocks the intersection of the laser lines 48, 49 projected on the work piece. By using the slide 70 to move the alignment guide 30 closer to the work piece 20, the length of the projected laser lines 48, 49 on the work piece increases. This increase in the length of the projected laser lines 48, 49 reduces the inaccuracies associated with an operator extrapolating the location of intersection point 50. With the embodiments shown in FIGS. 1-3 and 14-15, the distance between the axes of the laser generators 40, 41 and the drill bit axis 20 remains fixed as the alignment guide 30 and the slide 70 move with respect to the head 12. This maintains the alignment of the laser beams 44, 45 with the drill bit axis 20. Further, as machining operations are conducted on larger work pieces 20 that may interfere with the alignment guide 30, the alignment guide 30 may be repositioned through the slide 70.

The present invention is applicable to power tools having an axis of operation such as drill presses, gang drills, turret drills, multiple-spindle drills, boring machines, band saws, lathes, milling machines, etc. While the invention has been described with reference to details of the illustrated embodiment, these details are not intended to limit the scope of the invention as defined in the appended claims. For example, while the guide shafts have been illustrated as having straight shafts, shafts with other shapes may also be used, such as curved or angled shafts. In addition, other cross-sectional shapes and sizes for the guide shafts may also be used, such as polygonal shapes, including hexagons, octagons, etc., or rounded shapes such as ellipses. Further, in place of a rack and pinion transmission, the slide may use another type of transmission to create a mechanical advantage. A transmission made up of levers in a linkage system, pulleys, or a hydraulic or pneumatic actuator may also be used to transfer a mechanical advantage from the rotating knob to the slide. It is therefore intended that the foregoing detailed description be regarded as illustrative rather than limiting, and that it be understood that it is the following claims, including all equivalents, that are intended to define the spirit and scope of this invention.

1. A power tool comprising:
a. a spindle attached to the power tool and operably supported relative to a work piece, wherein the spindle defines an axis of operation for the power tool;
b. a slide moveably attached to the power tool; and
c. an alignment guide secured to the slide and having a first laser projecting a first laser beam in a first plane and a second laser projecting a second laser beam in a second plane, wherein the first plane and the second plane intersect along the axis of operation.

2. The power tool of claim 1, wherein the second laser is positioned at a fixed distance from the first laser.

3. The power tool of claim 1, wherein the alignment guide has at least one lamp.

4. The power tool of claim 3, wherein the at least one lamp is a light emitting diode.

5. The power tool of claim 1 further comprising a transmission mounted to the power tool and a rotary handle coupled with the transmission, and wherein the slide has a rack that is operably coupled with the transmission.

6. The power tool of claim 5, wherein the transmission has a gear operably coupled with the rack.

7. The power tool of claim 1, wherein the slide has at least one guide shaft attached to a bracket.

8. The power tool of claim 7, wherein the slide has a lock.

9. The power tool of claim 7, wherein the alignment guide has at least one bore, and wherein the at least one guide shaft extends through the at least one bore.

10. The power tool of claim 9, wherein the first plane is perpendicular to the second plane.

11. The power tool of claim 10, wherein the power tool is a drill press or a lathe.

12. A drill press comprising:
a. a vertical support post;
b. a head mounted to the support post having a rotatable chuck, wherein the rotatable chuck defines an axis of operation;
c. a slide attached to the drill press; and
d. an alignment guide secured to the slide and having a first laser projecting a first laser beam in a first plane and a second laser projecting a second laser beam in a second plane, wherein the first plane and the second plane intersect along the axis of operation.

13. The drill press of claim 12, wherein the second laser is positioned at a fixed distance from the first laser.

14. The power tool of claim 12, wherein the alignment guide has at least one lamp.

15. The power tool of claim 12, wherein the at least one lamp is a light emitting diode.

16. The drill press of claim 12 further comprising a transmission mounted to the drill press and a rotary handle coupled with the transmission, and wherein the slide has a rack that is operably coupled with the transmission.

17. The drill press of claim 16, wherein the transmission has a gear operably coupled with the rack.

18. The drill press of claim 16, wherein the slide has at least one guide shaft attached to a bracket.

19. The drill press of claim 18, wherein the slide has a lock.

20. The drill press of claim 18, wherein the alignment guide has at least one bore, and wherein the at least one guide shaft extends through the at least one bore.

21. The drill press of claim 20, wherein the first plane is perpendicular to the second plane.

22. The drill press of claim 18, wherein the slide is moveably attached to the head.

23. The drill press of claim 18, wherein the slide is attached to the support post.

24. A drill press comprising:
a. a base;
b. a vertical support post attached to the base;
c. a head mounted to the support post having a rotatable chuck, wherein the rotatable chuck defines an axis of operation;
d. a slide moveably attached to the drill press; and
e. an alignment guide secured to the slide and having a first laser projecting a first laser beam in a first plane and a second laser projecting a second laser beam in a second plane, wherein the second laser is positioned at a fixed distance from the first laser; and wherein the first plane and the second plane intersect along the axis of operation.

25. The drill press of claim 24 further comprising a gear rotatably mounted to the drill press and a rotary handle coupled with the gear, and wherein the slide has a rack that is operably coupled with the gear.
